(19) United States
(12) Patent Application Publication
(10) Pub. No.: US 2013/0282533 A1
(43) Pub. Date: Oct. 24, 2013

(54) PROVIDING AN ONLINE CONSUMER SHOPPING EXPERIENCE IN-STORE

(71) Applicants: Elizabeth Foran-Owens, Stamford, CT (US); Ken Rose, Stouffville (CA); Adam Robert Bell, West Harrison, NY (US); Lauren Grendon, Dublin (IE); Stephen Toner, Douglas (IE); Matthew Richard Stocke, Glendale, MO (US)

(72) Inventors: Elizabeth Foran-Owens, Stamford, CT (US); Ken Rose, Stouffville (CA); Adam Robert Bell, West Harrison, NY (US); Lauren Grendon, Dublin (IE); Stephen Toner, Douglas (IE); Matthew Richard Stocke, Glendale, MO (US)

(21) Appl. No.: 13/864,832

(22) Filed: Apr. 17, 2013

Related U.S. Application Data
(60) Provisional application No. 61/635,257, filed on Apr. 18, 2012.

(51) Int. Cl. G06Q 30/06

(52) U.S. Cl. CPC G06Q 30/0641
USPC 705/27.1

(57) ABSTRACT

Systems, methods and apparatus are described for providing an online shopping experience to a consumer who is shopping at a merchant's physical retail location. In an embodiment, a method includes a providing a consumer shopping experience website to obtain at least one of consumer registration data, consumer mobile device data, a consumer shopping list, merchant registration data, and merchant inventory data. In an implementation, a mobile shopping application is provided on a consumer's mobile device operable to provide information such as merchant store locations, merchant inventory, in-store product location data, product review information, and shopping cart information. The method includes receiving a request for shopping information, generating the requested shopping information, and transmitting the shopping information to the consumer mobile device in real time, while the consumer is in a merchant's store.

### CROSS REFERENCE TO RELATED APPLICATION(S)

This application claims the benefit of U.S. Provisional Patent Application No. 61/635,257 filed on Apr. 18, 2012, the contents of which are hereby incorporated by reference for all purposes.

### BACKGROUND

Technology has changed the way in which consumers shop for products and services. Due to the development of online shopping websites and of Smartphones that are capable of performing mobile product searches to research products, consumers are more informed and less inclined to ask for in-store assistance. Thus, although the in-store shopping experience provides the ability to touch and try a desired product and then leave the store with it, more and more consumers are instead treating “brick and mortar” stores as showrooms to test products and then make their purchases online.

The inventors have recognized that there is a need for a system, apparatus and processes to facilitate a more convenient and informative in-store shopping experience, which would allow consumers to quickly and efficiently locate products, retrieve information about products, and perform purchase transactions without waiting in a checkout line, so that the consumers can quickly and easily exit the store.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 illustrates a system for providing an online shopping experience to a consumer shopping at a merchant location according to an embodiment of the invention;

FIGS. 2A to 2E depict example screen shots taken from a consumer's mobile device of information that may be displayed while the consumer is shopping at a merchant retail location; and

FIG. 3 is a block diagram of an embodiment of a Consumer Experience Server computer according to an embodiment of the invention.

### DETAILED DESCRIPTION

In general, and for the purpose of introducing concepts of novel embodiments described herein, provided are systems, apparatus and methods for providing an online shopping experience to a consumer who is shopping at a “brick and mortar” or physical retail location of a merchant. In an embodiment, a consumer shopping experience website is provided that permits a consumer to enter and maintain a list of items to purchase at a merchant location (a shopping list). In addition, a mobile application is provided to the consumer for use to facilitate locating products in a store by using, for example enhanced global positioning satellite (GPS) technology. The mobile application may also be utilized to obtain information such as product reviews and ratings concerning products that are of interest to the consumer. In an implementation, the consumer uses a mobile device to scan a quick-response (QR) code (which is a two-dimensional code printed on a label or packaging that can be used to disseminate information) or to scan a universal product code (UPC) (which is a two-dimensional series of bars and numbers that typically identifies a manufacturer and product), or uses his or her mobile device to read a near-field communications (NFC) tag or a radio-frequency identifier (RFID) tag (or other such tag device) of a product in the store. After such an action, the desired information associated with that product is provided and typically displayed on a display screen of his or her mobile device. It should be understood that the consumer may utilize any dynamic authentication technology, including contactless technologies that utilize the EMV standards.

The consumer mobile application may also allow the consumer to receive real-time offers via push technology, or by a location-based web service, from the merchant while the consumer is shopping in the merchant's store. For example, a polling operation may be utilized to obtain the location of the consumer so that a particular offer can be determined and then transmitted to the consumer's mobile device for display to the consumer. In addition, some implementations of the mobile application permit the consumer to maintain a list of items in a virtual shopping cart that reflects the physical goods in the consumer's actual shopping cart, which list may be generated as the consumer scans codes from each item, or taps the items on an NFC reader, or reads an RFID tag on the goods as they are collected in the store. In addition, some embodiments of the mobile application permit the consumer to utilize his or her mobile device as a point-of-sale device to pay for the goods collected in the physical shopping cart. In some embodiments, the purchase transaction is carried out via an internet connection to a website configured to process the necessary data to consummate an electronic-commerce (or “eCommerce”) transaction.

According to embodiments described herein, a web application is also provided for use by merchants to submit inventory (lists of products available at particular store locations, which may include the including amount of the product available and a purchase price), receive analytics, manage offers, and confirm consumer In-Aisle purchases at the merchant's location.

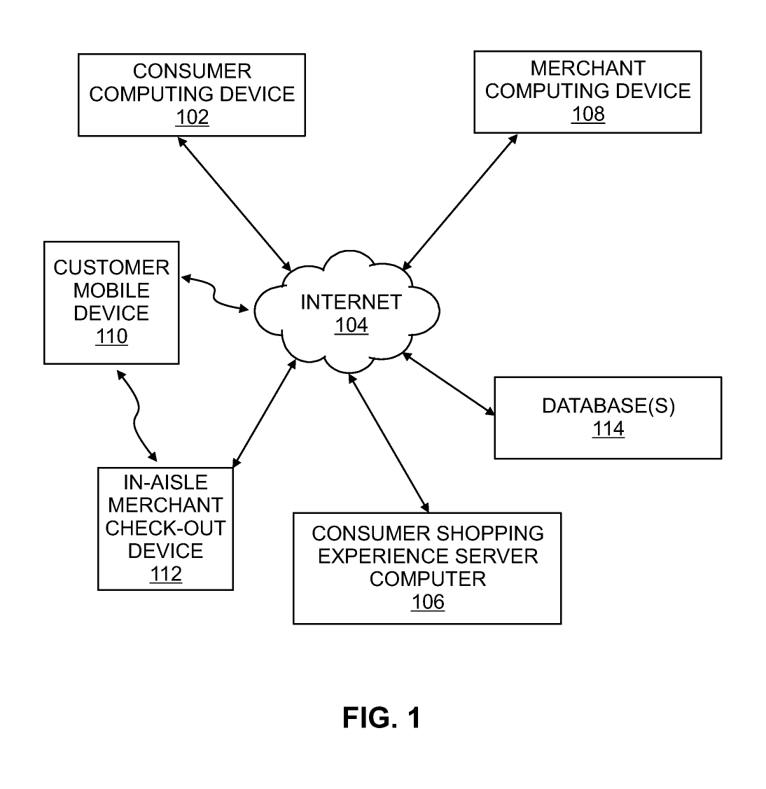

FIG. 1 is a block diagram illustrating a system 100 according to an embodiment that provides an online shopping experience to a consumer while shopping at a merchant location, such as a retail store. In an implementation, a consumer utilizes a computing device 102 capable of connecting to the internet 104, such as a personal computer or a tablet computer (such as an iPad™), to connect to a Consumer Shopping Experience Server computer 106 that hosts an enhanced consumer experience website. Similarly, the merchant utilizes a merchant computing device 108 to connect to the Consumer Experience Server computer 106 via the internet 104 and provides information, such as merchant inventory data, that can be accessed and/or utilized by the consumer before and during a visit to the merchant's store location. In an embodiment, the consumer utilizes a consumer mobile device 110, such as an iPad™, iPhone™, Android™ mobile device, mobile telephone, personal digital assistant (PDA), or Smartphone, that is operable to connect to the internet 104 and to receive information from the Consumer Shopping Experience Server computer 106. In some embodiments, provided in the merchant retail location are one or more In-Aisle merchant checkout devices 112. The system 100 may also include one or more databases 114 accessible by the Consumer Shopping Experience Server computer 106 via the internet 104, which store various types of information that may be used to enhance the in-store shopping experience of the consumer.

In some embodiments, the consumer registers as a participant by providing identification data that includes a mobile device identifier, such as a mobile telephone number and/or email address, so that information, messages, and/or offers can be transmitted to the consumer's mobile device when he or she is in the merchant's retail location. A web interface may be provided that allows the consumer to select a merchant location from a list of available merchant locations (which may be retail store locations), which list may also include the inventory available at each location. This list permits the consumer to determine whether or not certain desired items and/or products and/or services are available for sale at a particular merchant retail location before traveling there. The web interface permits the consumer to create a list of items to purchase (a shopping list) at a particular merchant location. Once the consumer has submitted the list, the items may be relayed to a Product Mapping Engine (not shown), which may be a part of the Consumer Shopping Experience Server computer 106, and a product database. The web interface also allows the consumer to add and remove items.

In some embodiments, the Product Mapping Engine maps the consumer's list of items, which are typically very general (such as, paper towels, diapers, toothpaste, and the like), to specific items and/or brands (for example, Bounty™ paper towels, Huggies™ diapers, Crest™ toothpaste, and the like) that are available at a merchant location such as a retail store. In an implementation, the Product Mapping Engine matches general items to specific products via keywords extracted from the consumer's list of items and from descriptions of products received from merchants (for example, an inventory list of items available at a particular merchant location can be matched to the items in the consumer's shopping cart). In some embodiments, merchants submit inventory listings to a products database and the Product Mapping Engine then utilizes the inventory listings to perform the translation from general product descriptions to specific items (such as brand-name and/or store brand items). In addition, in some embodiments the Product Mapping Engine may include a recommendation engine that is operable to recommend products to the consumer. Such product recommendations may be based on past purchasing behavior of the consumer and/or merchant data and/or other relevant data (which may include merchant inventory data and/or promotional products data).

In some embodiments, in addition to storing merchant inventory data, the product database may store product reviews, product ratings and specific product promotional offers associated with each merchant location (such as retail stores) for each product that the merchant designates either when registering (enrolling) or when updating merchant data. The product promotional offers may include product discount offers, product rebate offers, product benefit enhancements (such as an extended product warranty) that may be associated with one or more products for sale in a merchant wholesale or retail location, or other benefit or price reduction and the like. Such information can then be retrieved by the Consumer Shopping Experience Server computer 106, for example, from one or more databases 114.

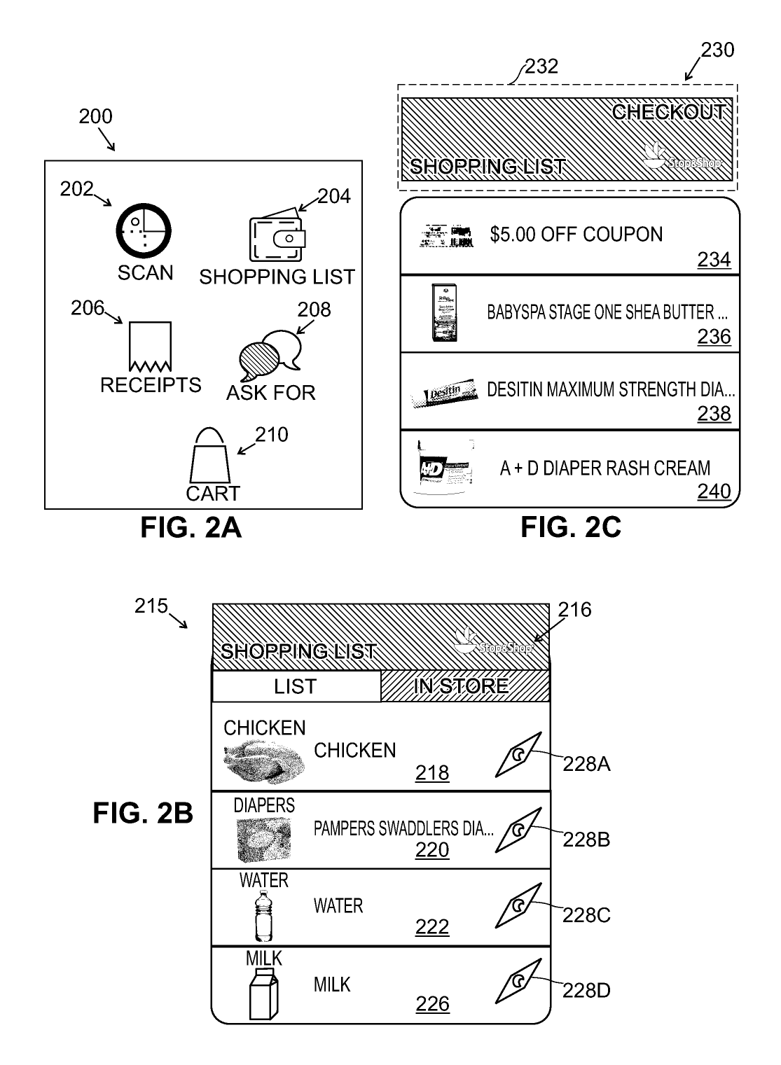

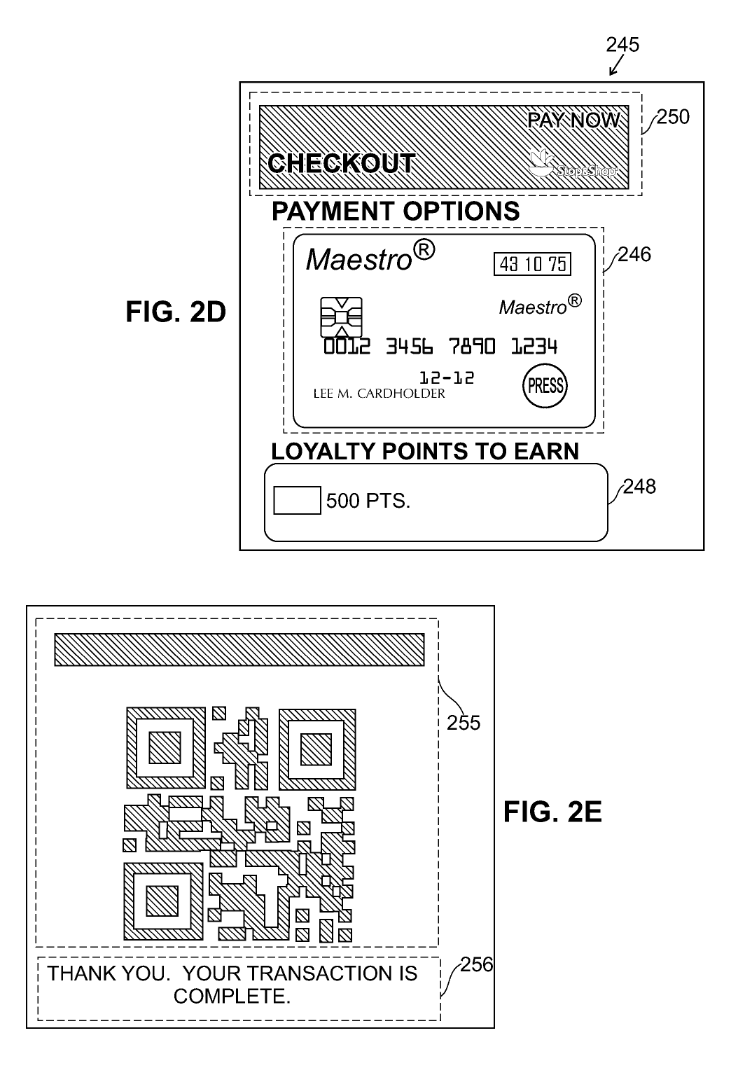

FIGS. 2A to 2E depict example screen shots taken from a consumer mobile device display screen showing various information that may be displayed as the consumer is shopping, for example, at a merchant retail location. In the examples shown, an “enhanced consumer shopping experience” mobile device application is being utilized by a consumer while shopping at a merchant retail location. The “enhanced consumer shopping experience” mobile application may have been downloaded or transmitted to the consumer's mobile device, such as to a Smartphone or tablet computer, during a registration process.

Referring to FIG. 2A, a shopping experience home screen 200 is shown that includes several options that are available for selection by the consumer. In particular, the consumer can select a scan option 202, a shopping list option 204, a receipts option 206, an “ask for” option 208 and/or a “cart” option 210. If the consumer selects the shopping list icon 204, for example by pressing on the icon on the touch screen of her mobile telephone, then the shopping list 215 of FIG. 2B appears. Shown is only a portion of the shopping list 215, and the consumer may be able to scroll the list to reveal other items on the list. As shown, a store icon 216 indicates the merchant retail location (here a food store) that the consumer is currently visiting, and the shopping list includes various food items including chicken 218, diapers 220, bottled water 222 and milk 226. Each of the buttons includes a locator icon 228A to 228D associated with each product button that may be selected by the consumer to either find the location of the product in-store, and/or to find out more information regarding the product.

In some embodiments, the enhanced customer shopping experience mobile application includes a product locator that may utilize GPS and/or WiFi native to Smartphones to pinpoint locations of items in the merchant retail location. For example, a publicly available system such as Skyhook, which operates using WiFi locations, may be utilized to help determine a finer grained location of a product. In an implementation, the GPS technology available in the Smartphone is combined with coordinates obtained by triangulating available WiFi SSID's (a Service Set Identifier of SSID is an alphanumeric key that uniquely identifies a wireless local area network (LAN)), media access control (MAC) addresses and/or signal strength to determine a particular product's location within the merchant's physical store. This fine granularity allows the product locator to give the consumer more than a general direction to head in while in the retail location in order to find a product quickly. For example, when the product locator icon 228A is pressed by the consumer, a graphical representation of a store floor plan layout (not shown) may be provided on the display screen of the consumer's mobile telephone while the consumer is physically present in the merchant's store. An icon representing the current position of the consumer within the store may be superimposed on the floor plan, along with an arrow pointing in the direction in which the consumer should walk to arrive at the location of the chicken products. A second icon, which may be an “X” icon, may be provided off-screen which indicates the spot where a particular brand of chicken product is located. The consumer may then be able to scroll the floor plan in the direction of the arrow until the second icon (the “X” icon) appears which is also superimposed on the floor plan display, wherein the second icon represents the position of the particular brand of chicken food product preselected by the consumer. Alternately or in addition, the floor plan may scroll or move automatically as the consumer moves in the direction of the target product.

In some embodiments of the mobile application, a bootstrapping of product locations may be performed as consumers compile a list of items in their physical shopping carts and utilize the product locator in a particular merchant retail location, which builds a location database of products. For example, as a consumer locates products in the merchant store, he or she scans each product with the consumer mobile device to generate a list of products that includes associated GPS coordinates. These coordinates associated with each product are then stored in the location database for that merchant location. Thus, when other consumers utilize the mobile shopping application and wish to find a particular product, the location database can be searched to see if GPS coordinates for that product are already available for use in providing a map for that consumer. In addition, merchant staff may be provided with a merchant version of the mobile shopping application in order to scan products so as to input product location data, for example, when stocking shelves with merchandise or when relocating a product or products to different areas in the store and/or to different store shelves. In this manner, most if not all products in a merchant store location can be associated with location coordinates for use by consumers to find desired products by using their mobile shopping application.

In an example, a consumer may retrieve information about a product using a Product Information Retriever, which requires the consumer to scan an identifier of the product with his or her mobile device. In this case, the system learns that the product is located in that position in the merchant's retail store, so that product's location is sent to the Product Mapping Engine and stored in a database along with position coordinates. In this manner, the Product Mapping Engine learns over time where products are located within a particular merchant's store and can use that information to optimize the path that consumers should take in the future when a request is made regarding the location of such products.

In some embodiments, the enhanced consumer shopping experience mobile application downloaded to the consumer's mobile device includes a product information retriever that provides a system and interface to retrieve product reviews, product ratings and product offers while the consumer is shopping in the merchant's store. In some implementations, the consumer obtains a product identifier before the information can be transmitted for display on the consumer's mobile device. The product identifier can be obtained by using any number of technologies that are supported by Smartphones or tablet computers, for example, such as NFC (Near Field Communication), QR Code (Quick Response Code), and/or UPC (Universal Product Code) scanning. For example, the consumer can utilize her Smartphone to scan a QR code printed on the outside wrapper of a food item, which is then relayed to the Product Mapping Engine which checks one or more databases storing product reviews, product ratings and product-relevant offers. One or more of these can be returned to the user interface for display on the consumer's Smartphone.

As mentioned above, in addition to transmitting the product identifier, the location of the product (which may be in the form of latitude and longitude) is transmitted to the Product Mapping Engine, which provides such data to the Product Locator application. In addition, in some implementations, real-time offers utilize the product locator to track the consumer's location while he or she is in the merchant's store, and transmits to the consumer's mobile device one or more product offers that are based on the consumer's in-store location. For example, if the consumer scanned the UPC code for a particular brand of toothpaste, then the system recognizes that the consumer is on the first floor in aisle eight of the merchant's store and then transmits a coupon for $1 off the price of a specific brand of mouthwash located in that same aisle. Thus, the product offers are relevant to where the consumer is currently located, and the merchant may also have the ability to customize any of the offers that are to be transmitted to consumers.

FIG. 2C illustrates a shopping cart display screen 230 that lists various products and/or items in the consumer's physical shopping cart in the store. A checkout icon 232 is also provided so that when the consumer is finished shopping, he or she can start a checkout process (which will be explained below). Referring again to FIG. 2C, the shopping cart includes listings for a five dollar off coupon 234, a baby spa stage 1 product 236, Desitin®diaper rash cream 238, and A+D® diaper rash cream 240. Each of the icons for these products may be selected by the consumer by pressing on the touch screen display in order to obtain further information concerning that product, which may include product review information and pricing information.

Furthermore, in some embodiments, as the consumer obtains products from the store shelves and places them in his or her physical shopping cart, the consumer scans an identifier on each product so that the shopping list 215 tracks the consumer's physical or actual shopping items placed in the shopping cart 230. For example, as the consumer shops in the merchant store he or she adds items to the shopping cart 230 by tapping her NFC enabled Smartphone to an NFC tag on each product. A running subtotal of items and their cost can also be tracked in this manner, so that the consumer can determine how much money she will need to spend if she were to purchase all the items in the store shopping cart.

In an embodiment, the enhanced consumer shopping experience mobile application downloaded to the consumer's mobile device may include a point of sale application or checkout application that enables the consumer to checkout anytime from an in-store, in-aisle merchant checkout device. In particular, assuming that the consumer has been scanning each product by using his or her mobile device as the items are placed in the store shopping cart, then an eCommerce transaction may be performed which permits the consumer to avoid standing in a checkout line. For example, FIG. 2D depicts a “Pay Now” screen 245 that is displayed if the consumer selects the “Checkout” icon 232 shown in FIG. 2C. The display screen includes a payment options list 246, which in the example shown in FIG. 2D depicts a “Maestro” credit card, and included is a “Loyalty Points to Earn” portion 248 showing that if the consumer utilizes that credit card account then she will also receive 500 loyalty points. Other payment options (not shown) may be available to the consumer by, for example, scrolling downwards to bring up more card accounts, which may depend on the financial accounts and/or store loyalty accounts associated with a particular consumer. For example, a consumer may have a digital wallet that stores information on his or her mobile telephone concerning one or more credit card accounts, debit card accounts and/or store loyalty card accounts.

Referring again to FIG. 2D, after selecting a payment card account to complete the purchase, the consumer presses the “Pay Now” icon 250. The purchase transaction data is then transmitted to a payment card system (not shown) for processing and approval. After the purchase transaction has been authorized and/or approved, the consumer's mobile device receives a confirmation of payment which is presented on the display screen 255 as shown in FIG. 2E in the form of a QR code. A message 256 may also appear that indicates that the purchase transaction is complete: “Thank you. Your transaction is complete”. The consumer then presents this QR code 255 to a merchant device running a Merchant In-Aisle Checkout application for scanning so that the consumer can proceed to leave the merchant store. In some embodiments, an employee of the merchant may be stationed at each exit of the retail store to check the QR codes of consumers who have checked out in this manner. In some implementations, the merchant device may be operable to print out a receipt for the consumer to show store personnel while exiting the store that confirms a successful check-out (that the consumer has paid for the merchandise).

In some implementations of the enhanced consumer shopping experience system, consumers may be charged a nominal fee for use of the system, such as a penny for each use. However, in other embodiments, use of the enhanced consumer shopping experience system application is free to the consumer, and merchants pay a nominal fee to be active participants in the system. Merchants may be willing to pay a fee for use of the enhanced consumer shopping experience system because the Consumer Shopping Experience Server computer 106 may be operable to store and analyze data that can be processed to provide valuable analytics data to the merchants. For example, a comparison may be made between the original shopping list and the final purchased list (or the items that are in the consumer's physical shopping cart), and any new items that were added during shopping are registered and/or stored for further analysis. In some embodiments, information analytics are conducted to understand the efficiency of various events (for example, the success or failure of special promotions, pushed offers, enhanced loyalty points and/or special rewards, the placement of items or products in the store, the placement of signage in the store, the availability and/or use of salesman and/or other floor personnel in the store, and the like) to drive additional, unexpected purchases. Merchants may be willing to pay a fee to be provided with such analytics in order to improve the effectiveness of their methods of encouraging consumers to purchase products. In addition, the Consumer Shopping Experience Server computer 106 may be operable to provide product offer management to merchants, to provide immediate coupon redemption to consumers (for example by reducing the price of a product by a coupon amount when the consumer enters into a payment transaction), and to process and confirm in-Aisle purchases of consumers.

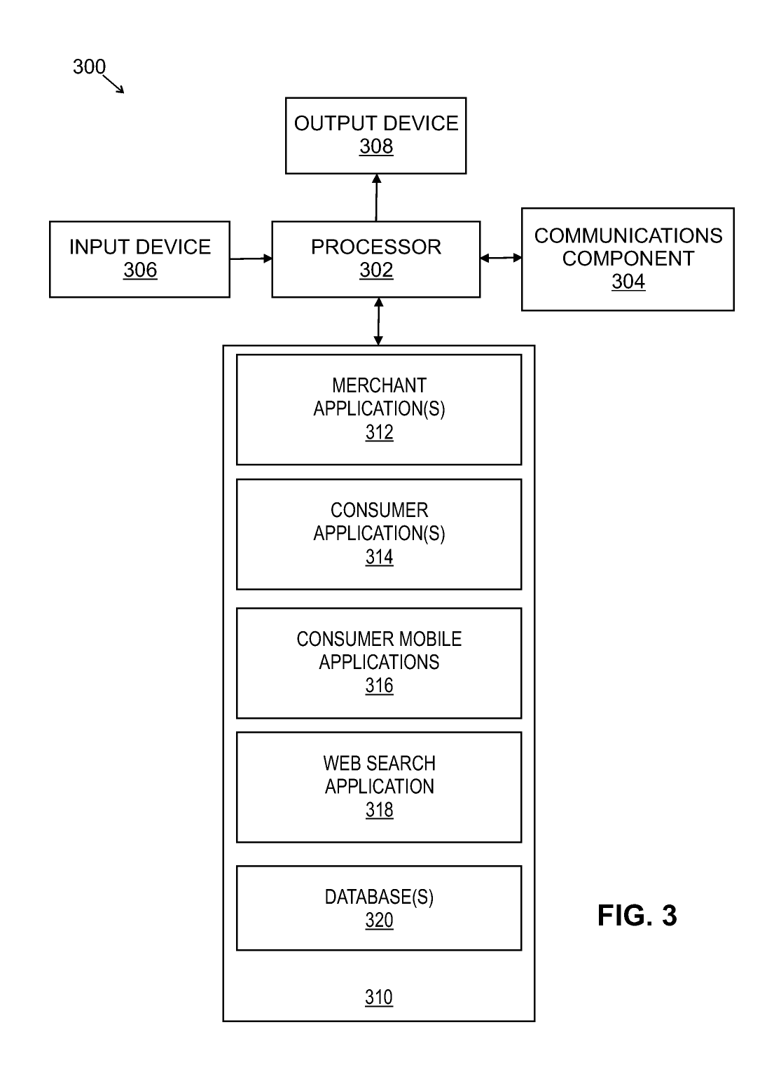

FIG. 3 is a block diagram of an embodiment of a Consumer Shopping Experience Server computer 300. The Consumer Shopping Experience Server computer 300 may be conventional in its hardware aspects but may be controlled by software to cause it to operate in accordance with aspects of the methods presented herein. In particular, the Consumer Shopping Experience Server computer 300 may include a computer processor 302 operatively coupled to a communication component 304, an input device 306, an output device 308, and a storage device 310.

The computer processor 302 may constitute one or more conventional processors. Processor 302 operates to execute processor-executable steps, contained in program instructions described herein, so as to control the Consumer Shopping Experience Server computer 200 to provide desired functionality.

Communication device 304 may be used to facilitate communication with, for example, other devices (such as for receiving data from a QR code reader or an RFID reader of a merchant and for transmitting data to a Smartphone or to an iPad™ or other tablet computer of the consumer). Communication device 304 may also, for example, have capabilities for engaging in data communications over conventional computer-to-computer data networks, in a wired or wireless manner. Such data communications may be in digital form and/or in analog form.

Input device 306 may comprise one or more of any type of peripheral device typically used to input data into a computer. For example, the input device 306 may include a keyboard and a mouse and/or a touchpad that may be used, for example, by a systems engineer or other personnel authorized to, for example, perform server computer system maintenance or other tasks. The output device 308 may comprise, for example, a display and/or a printer.

Storage device 310 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium”.

Storage device 310 stores one or more programs for controlling processor 302. The programs comprise program instructions that contain processor-executable process steps of the Consumer Experience Server computer 300, including, in some cases, process steps that constitute processes provided in accordance with principles of the processes presented herein.

The programs may include a merchant application 312 that manages a process by which merchants register with the system and maintain merchant inventory lists regarding the products and/or merchandise available in one or more retail store locations. The merchants may self-register by accessing a Consumer Shopping Experience merchant web page that includes a merchant interface for providing required information. The programs may also include a consumer application that manages a process wherein consumers register themselves and their mobile devices with the Consumer Shopping Experience Server computer 300, and that permits the consumer to manage one or more shopping lists. In some embodiments, the Consumer Shopping Experience account registration process may allow consumers to register themselves with the Consumer Shopping Experience Server computer 300 by accessing, for example via their mobile telephone or tablet computer, a suitable web page hosted by the Consumer Shopping Experience Server computer 300. The information gathered from the consumer during the registration process may include the consumer's name, a primary payment card account number (PAN), and mobile telephone number (or other mobile identifier).

The storage device 310 may also store a consumer mobile shopping application 316 for downloading by the consumer to his or her mobile device for use while shopping in the merchant's retail store location. In some implementations, the consumer mobile shopping application 316 includes a Product Mapping Engine and Database component, a Product Locator component, a Product Information Retriever component, a Real-Time Offers component, a virtual Shopping Cart component, and a Point of Sale/In-Aisle Checkout component. The details concerning operation of each of these components have been discussed above.

The storage device 310 may also include a web search component 318 that may permit the consumer to search the internet for information concerning one or more products offered by a merchant. In addition, one or more databases 320 may be maintained by the Consumer Shopping Experience Server computer 300 on the storage device 310. Among these databases may be, for example, a consumer database, a merchant database, a products database, and an analytics database.

The application programs of the Consumer Shopping Experience Server computer 300, as described above, may be combined in some embodiments, as convenient, into one, two or more application programs. Moreover, the storage device 310 may store other programs or applications, such as one or more operating systems, device drivers, database management software, web hosting software, business intelligence software (for example, to determine analytics which may be useful to merchants), and the like.

Accordingly, through use of the Enhanced Consumer Shopping Experience system, the merchant has an opportunity to provide relevant product location data, product review data and product offers in real-time to consumers who are shopping in their retail establishments. Consumers can utilize the enhanced consumer shopping experience system to create and manage shopping lists, and to enhance their retail store shopping experience by obtaining data that makes it easier and quicker for them to find products in the store, and that enables them to easily and quickly checkout without having to queue up in a typical line behind other consumers making purchases at a checkout counter. Furthermore, consumers can receive promotional offers from merchants in real-time while they are in the retail store and thus able to physically retrieve the promotional items so as to take advantage of, for example, a discounted price. Such promotional offers may be highly relevant to the consumers because they may be based on the consumers' needs as exhibited by similar items on the customer's shopping list, or in that consumer's purchasing history.

As the term “payment transaction” is used herein and in the appended claims, it should be understood to include the types of transactions commonly referred to as “purchase transactions”, which may be in connection with eCommerce transactions that may involve payment card accounts and/or payment card systems.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
providing, by a server computer, a consumer shopping experience website to obtain at least one of consumer registration data, consumer mobile device data, a consumer shopping list, merchant registration data, and merchant inventory data;
providing, by the server computer to a consumer mobile device, a mobile shopping application configured to access and provide information concerning at least one of merchant store locations, merchant inventory data, in-store product location data, product review information, and shopping cart information;
receiving, by the server computer, a request for shopping information from the consumer mobile shopping application;
generating the requested shopping information; and
transmitting, by the server computer to the consumer mobile device in real time, the shopping information while the consumer is in a merchant's store.

2. The method of claim 1, wherein receiving the request for shopping information comprises receiving at least one of a quick response (QR) code, a universal product code (UPC), and product data from a tag.

3. The method of claim 1, wherein generating the shopping information comprises at least one of retrieving the requested information from at least one database, and mapping general item descriptions to specific items available in the merchant's store.

4. The method of claim 1, wherein generating the shopping information further comprises generating recommended products data based on at least one of past purchasing behavior of the consumer, merchant inventory data, and promotional product data.

5. The method of claim 1, wherein transmitting the shopping information further comprises providing at least one of a shopping list, product information, and a location of a product in the merchant's store.

6. The method of claim 1, wherein the consumer mobile device data comprises at least one of a mobile telephone number and a consumer email address.

7. The method of claim 1, further comprising:
determining, based on the request for shopping information and data supplied by a merchant, at least one product promotional offer; and
transmitting, by the server computer to the consumer mobile device while the consumer is in the merchant's store, the at least one product promotional offer.

8. The method of claim 1, further comprising:
receiving, by the server computer, consumer location data based on at least one of global positioning satellite (GPS) data and WiFi data native to the consumer mobile device;
determining, based on the consumer location data, at least one product promotional offer; and
transmitting, by the server computer to the consumer mobile device while the consumer is in the merchant's store, the at least one product promotional offer.

9. The method of claim 1, further comprising:
receiving, by the server computer, data identifying products in a physical shopping cart of the consumer shopping in a merchant store;
comparing, by the server computer, the data identifying the products in the physical shopping cart to a shopping list generated by the consumer, wherein the shopping list is associated with the merchant store;
determining that at least one product in the physical shopping cart is not on the shopping list;
determining analytics data based on at least one in-store event data associated with the at least one product in the physical shopping cart that is not on the shopping list, the in-store event data provided by the merchant; and
providing, by the server computer, the analytics data to the merchant.

10. The method of claim 9, wherein the analytics data comprises efficiency data associated with the at least one in store event concerning an ability to drive the purchase of the at least one additional product.

11. The method of claim 9, further comprising charging a fee to the merchant for providing the analytics data.

12. The method of claim 1, further comprising providing, by the server computer to the consumer mobile device, a checkout application, wherein the checkout application is configured to permit a consumer to perform a purchase transaction with the consumer mobile device.

13. The method of claim 1, further comprising:
transmitting, by the server computer to an in-aisle checkout device in a merchant location, an in-aisle checkout application, wherein the in-aisle checkout application is configured to allow the in-aisle checkout device to scan a QR code from the consumer mobile device representing confirmation of a purchase transaction.

14. An apparatus comprising:
a processor;
a communication device operably coupled to the processor; and
a storage device operably coupled to the processor and storing instructions configured to cause the processor to:
provide a consumer shopping experience webpage to obtain at least one of consumer registration data, consumer mobile device data, a consumer shopping list, merchant registration data, and merchant inventory data;
provide to a consumer mobile device, a mobile shopping application configured to access and provide information concerning at least one of merchant store locations, merchant inventory data, in-store product location data, product review information, and shopping cart information;
receive a request for shopping information from the consumer mobile shopping application;
generate the requested shopping information; and
transmit to the consumer mobile device in real time, the shopping information while the consumer is in a merchant's store.

15. The apparatus of claim 14, wherein the instructions for receiving the request for shopping information further comprises instructions configured to cause the processor to receive and process at least one of a quick response (QR) code, a universal product code (UPC), and product data from a tag.

16. The apparatus of claim 14, wherein the instructions for generating the shopping information further comprises instructions configured to cause the processor to at least one of retrieve the requested information from at least one database, and map general item descriptions to specific items available in the merchant's store.

17. The apparatus of claim 14, wherein the instructions for generating the shopping information further comprises instructions configured to cause the processor to generate recommended products data based on at least one of past purchasing behavior of the consumer, merchant inventory data, and promotional product data.

18. The apparatus of claim 14, wherein the instructions for transmitting the shopping information further comprises instructions configured to cause the processor to provide at least one of a shopping list, product information, and a location of a product in the merchant's store.

19. The apparatus of claim 14, wherein the storage device further comprises instructions configured to cause the processor to:
determine, based on the request for shopping information and data supplied by a merchant, at least one product promotional offer; and
transmit to the consumer mobile device while the consumer is in the merchant's store, the at least one product promotional offer.

20. The apparatus of claim 14, wherein the storage device further comprises instructions configured to cause the processor to:
receive consumer location data based on at least one of global positioning satellite (GPS) data and WiFi data native to the consumer mobile device;
determine, based on the consumer location data, at least one product promotional offer; and
transmit to the consumer mobile device while the consumer is in the merchant's store, the at least one product promotional offer.

21. The apparatus of claim 14, wherein the storage device further comprises instructions configured to cause the processor to:
receive data identifying products in a physical shopping cart of the consumer shopping in a merchant store;
compare the data identifying the products in the physical shopping cart to a shopping list generated by the consumer, wherein the shopping list is associated with the merchant store;
determine that at least one product in the physical shopping cart is not on the shopping list;
determine analytics data based on at least one in-store event data associated with the at least one product in the physical shopping cart that is not on the shopping list, the in-store event data provided by the merchant; and
provide the analytics data to the merchant.

22. The apparatus of claim 21, wherein the storage device further comprises instructions configured to cause the processor to charge a fee to the merchant for providing the analytics data.

23. The apparatus of claim 14, wherein the storage device further comprises instructions configured to cause the processor to provide to the consumer mobile device, a checkout application, wherein the checkout application is configured to permit a consumer to perform a purchase transaction without waiting in a checkout line.
